(19) United States
(12) Patent Application Publication
(10) Pub. No.: US 2017/0344898 A1
(43) Pub. Date: Nov. 30, 2017

(54) METHODS AND SYSTEMS FOR SETTING A SYSTEM OF SUPER CONDUCTING QUBITS HAVING A HAMILTONIAN REPRESENTATIVE OF A POLYNOMIAL ON A BOUNDED INTEGER DOMAIN

(71) Applicant: 1QB Information Technologies Inc., Vancouver (CA)

(72) Inventors: Sahar KARIMI, Vancouver (CA); Pooya RONAGH, Vancouver (CA)

(21) Appl. No.: 15/165,655

(22) Filed: May 26, 2016

(51) Int. Cl. G06N 99/00; G06F 15/78

(52) U.S. Cl. CPC G06N 99/002; G06F 15/78

(57) ABSTRACT

Described herein are methods, systems, and media for setting a system of superconducting qubits having a Hamiltonian representative of a polynomial on a bounded integer domain via bounded-coefficient encoding. The method comprises: obtaining the polynomial on the bounded integer domain and integer encoding parameters; computing bounded-coefficient encoding using the integer encoding parameters; recasting each integer variable as a linear function of binary variables using the bounded-coefficient encoding, and providing additional constraints on the attained binary variables to avoid degeneracy in the encoding; substituting each integer variable with an equivalent binary representation, and computing the coefficients of the equivalent binary representation of the polynomial on the bounded integer domain; performing a degree reduction on the obtained equivalent binary representation of the polynomial to provide an equivalent polynomial of degree at most two in binary variables; using which, setting local field biases and coupling strengths on the system of superconducting qubits.

### BACKGROUND

Systems of superconducting qubits are disclosed for instance in US20120326720 and US20060225165 and manufactured by D-Wave Systems, IBM, and Google. Such analogue systems are used for implementing quantum computing algorithms, for example, the quantum adiabatic computation proposed by Farhi et. al. [arXiv:quant-ph/0001106] and Grover's quantum search algorithm [arXiv:quant-ph/0206003].

Disclosed invention herein relates to quantum information processing. Many methods exist for solving a binary polynomially constrained polynomial programming problem using a system of superconducting qubits. The method disclosed herein can be used in conjunction with any method on any solver for solving a binary polynomially constrained polynomial programming problem to solve a mixed-integer polynomially constrained polynomial programming problem.

### SUMMARY

Current implementations of quantum devices have limited numbers of superconducting qubits and are furthermore prone to various sources of noise. In practice, this restricts the usage of the quantum device to a limited number of qubits and a limited range of applicable ferromagnetic biases and couplings. Therefore there is need for methods of efficient encoding of data on the qubits of a quantum device.

Disclosed invention herein relates to quantum information processing. This application pertains to a method for storing integers on superconducting qubits and setting a system of such superconducting qubits having a Hamiltonian representative of a polynomial on a bounded integer domain.

The method disclosed herein can be used as a preprocessing step for solving a mixed integer polynomially constrained polynomial programming problem with a solver for binary polynomially constrained polynomial programming problems. One way to achieve the mentioned conversion is to cast each integer variable x as a linear function of binary variables, yᵢ for i=1, . . . , d:

x=Σᵢ₌₁^{d}cᵢyᵢ

The tuple (c₁, . . . , c_{d}) is what's referred to as an integer encoding. A few well-known integer encodings are:

Binary Encoding, in which cᵢ=2ⁱ⁻¹.
Unary Encoding, in which cᵢ=1.

Sequential Encoding, in which cᵢ=i.

Current implementations of quantum devices have limited numbers of superconducting qubits and are furthermore prone to various sources of noise, including thermal and decoherence effects of the environment and the system [arXiv:1505.01545v2]. In practice, this restricts the usage of the quantum device to a limited number of qubits and a limited range of applicable ferromagnetic biases and couplings.

Consequently the integer encodings formulated above, become incompetent for representing polynomial in several integer variables as the Hamiltonian of the systems mentioned above. The unary encoding suffers from exploiting a large number of qubits and on the other hand, in the binary and sequential encoding the coefficients cᵢ can be too large and therefore the behavior of the system is affected considerably by the noise.

In an aspect, disclosed herein is a method for setting a system of superconducting qubits having a Hamiltonian representative of a polynomial on a bounded integer domain via bounded-coefficient encoding, the method comprising: using one or more computer processors to obtain (i) the polynomial on the bounded integer domain and (ii) integer encoding parameters; computing a bounded-coefficient encoding using the integer encoding parameters; recasting each integer variable as a linear function of binary variables using the bounded-coefficient encoding, and providing additional constraints on the attained binary variables to avoid degeneracy in the encoding, if required by a user; substituting each integer variable with an equivalent binary representation, and computing the coefficients of the equivalent binary representation of the polynomial on the bounded integer domain; performing a degree reduction on the obtained equivalent binary representation of the polynomial on the bounded integer domain to provide an equivalent polynomial of degree at most two in binary variables; and setting local field biases and coupling strengths on the system of superconducting qubits using the coefficients of the derived polynomial of degree at most two in several binary variables. In some embodiments, the polynomial on a bounded integer domain is a single bounded integer variable. In further embodiments, setting local field biases and coupling strengths comprises assigning a plurality of qubits to have a plurality of corresponding local field biases; each local field bias corresponding to each of the qubits in the plurality of qubits is provided using the parameters of the integer encoding. In some embodiments, the polynomial on a bounded integer domain is a linear function of several bounded integer variables. In further embodiments, setting local field biases and coupling strengths comprises assigning a plurality of qubits to have a plurality of corresponding local field biases; each local field bias corresponding to each of the qubits in the plurality of qubits is provided using the linear function and parameters of the integer encoding. In some embodiments, the polynomial on a bounded integer domain is a quadratic polynomial of several bounded integer variables. In further embodiments, setting local field biases and coupling strengths comprises embedding the equivalent binary representation of the polynomial of degree at most two on a bounded integer domain to the layout of a system of superconducting qubits comprising local fields on each of the plurality of the superconducting qubits and couplings in a plurality of pairs of the plurality of the superconducting qubits. In some embodiments, the system of superconducting qubits is a quantum annealer. In further embodiments, the method comprises performing an optimization of the polynomial on a bounded integer domain via bounded-coefficient encoding. In further embodiments, the optimization of the polynomial on a bounded integer domain via bounded-coefficient encoding is obtained by quantum adiabatic evolution of an initial transverse field on the superconducting qubits to the final Hamiltonian on a measurable axis. In further embodiments, the optimization of the polynomial on a bounded integer domain via bounded-coefficient encoding comprises: providing the equivalent polynomial of degree at most two in binary variables; providing a system of non-degeneracy constraints; and solving the problem of optimization of the equivalent polynomial of degree at most two in binary variables subject to the system of non-degeneracy constraints as a binary polynomially constrained polynomial programming problem. In some embodiments, the method comprises solving a polynomially constrained polynomial programming problem on a bounded integer domain via bounded-coefficient encoding. In some embodiments, solving the polynomially constrained polynomial programming problem on a bounded integer domain via bounded-coefficient encoding is obtained by quantum adiabatic evolution of an initial transverse field on the superconducting qubits to the final Hamiltonian on a measurable axis. In further embodiments, solving the polynomially constrained polynomial programming problem on a bounded integer domain via bounded-coefficient encoding comprises: computing the bounded-coefficient encoding of the objective function and constraints of the polynomially constrained polynomial programming problem using the integer encoding parameters to obtain an equivalent polynomially constrained polynomial programming problem in several binary variables; providing a system of non-degeneracy constraints; adding the system of non-degeneracy constraints to the constraints of the obtained polynomially constrained polynomial programming problem in several binary variables; and solving the problem of optimization of the obtained polynomially constrained polynomial programming problem in several binary variables. In some embodiments, the obtaining of integer encoding parameters comprises obtaining an upper bound on the coefficients of the bounded-coefficient encoding directly. In some embodiments, the obtaining of integer encoding parameters comprises obtaining an upper bound on the coefficients of the bounded-coefficient encoding based on error tolerances ∈ₗ and ∈_{c} of local field biases and couplings strengths of the system of superconducting qubits. In some embodiments, obtaining an upper bound on the coefficient of the bounded-coefficient encoding comprises finding a feasible solution to a system of inequality constraints.

In another aspect, disclosed herein is a system comprising: a sub-system of superconducting qubits; a computer operatively coupled to the sub-system of superconducting qubits, wherein the computer comprises at least one computer processor, an operating system configured to perform executable instructions, and a memory; and a computer program including instructions executable by the at least one computer processor to generate an application for setting the sub-system of superconducting qubits having a Hamiltonian representative of a polynomial on a bounded integer domain via bounded-coefficient encoding, the application comprising: a software module programmed or otherwise configured to obtain the polynomial on the bounded integer domain; a software module programmed or otherwise configured to obtain integer encoding parameters; a software module programmed or otherwise configured to compute a bounded-coefficient encoding using the integer encoding parameters; a software module programmed or otherwise configured to recast each integer variable as a linear function of binary variables using the bounded-coefficient encoding, and providing additional constraints on the attained binary variables to avoid degeneracy in the encoding, if required by a user; a software module programmed or otherwise configured to substitute each integer variable with an equivalent binary representation, and compute the coefficients of the equivalent binary representation of the polynomial on the bounded integer domain; a software module programmed or otherwise configured to perform a degree reduction on the obtained equivalent binary representation of the polynomial on the bounded integer domain to provide an equivalent polynomial of degree at most two in binary variables; and a software module programmed or otherwise configured to set local field biases and coupling strengths on the system of superconducting qubits using the coefficients of the derived polynomial of degree at most two in several binary variables. In some embodiments, the polynomial on a bounded integer domain is a single bounded integer variable. In further embodiments, setting local field biases and coupling strengths comprises assigning a plurality of qubits to have a plurality of corresponding local field biases; each local field bias corresponding to each of the qubits in the plurality of qubits is provided using the parameters of the integer encoding. In some embodiments, the polynomial on a bounded integer domain is a linear function of several bounded integer variables. In further embodiments, setting local field biases and coupling strengths comprises assigning a plurality of qubits to have a plurality of corresponding local field biases; each local field bias corresponding to each of the qubits in the plurality of qubits is provided using the linear function and parameters of the integer encoding. In some embodiments, the polynomial on a bounded integer domain is a quadratic polynomial of several bounded integer variables. In further embodiments, setting local field biases and coupling strengths comprises embedding the equivalent binary representation of the polynomial of degree at most two on a bounded integer domain to the layout of a system of superconducting qubits comprising local fields on each of the plurality of the superconducting qubits and couplings in a plurality of pairs of the plurality of the superconducting qubits. In some embodiments, the system of superconducting qubits is a quantum annealer. In further embodiments, the system comprises performing an optimization of the polynomial on a bounded integer domain via bounded-coefficient encoding. In further embodiments, the optimization of the polynomial on a bounded integer domain via bounded-coefficient encoding is obtained by quantum adiabatic evolution of an initial transverse field on the superconducting qubits to the final Hamiltonian on a measurable axis. In further embodiments, the optimization of the polynomial on a bounded integer domain via bounded-coefficient encoding comprises: providing the equivalent polynomial of degree at most two in binary variables; providing a system of non-degeneracy constraints; and solving the problem of optimization of the equivalent polynomial of degree at most two in binary variables subject to the system of non-degeneracy constraints as a binary polynomially constrained polynomial programming problem. In some embodiments, the system comprises solving a polynomially constrained polynomial programming problem on a bounded integer domain via bounded-coefficient encoding. In some embodiments, solving the polynomially constrained polynomial programming problem on a bounded integer domain via bounded-coefficient encoding is obtained by quantum adiabatic evolution of an initial transverse field on the superconducting qubits to the final Hamiltonian on a measurable axis. In further embodiments, solving the polynomially constrained polynomial programming problem on a bounded integer domain via bounded-coefficient encoding comprises: computing the bounded-coefficient encoding of the objective function and constraints of the polynomially constrained polynomial programming problem using the integer encoding parameters to obtain an equivalent polynomially constrained polynomial programming problem in several binary variables; providing a system of non-degeneracy constraints; adding the system of non-degeneracy constraints to the constraints of the obtained polynomially constrained polynomial programming problem in several binary variables; and solving the problem of optimization of the obtained polynomially constrained polynomial programming problem in several binary variables. In some embodiments, the obtaining of integer encoding parameters comprises obtaining an upper bound on the coefficients of the bounded-coefficient encoding directly. In some embodiments, the obtaining of integer encoding parameters comprises obtaining an upper bound on the coefficients of the bounded-coefficient encoding based on error tolerances ∈ₗ and ∈_{c} of local field biases and couplings strengths of the system of superconducting qubits. In some embodiments, obtaining an upper bound on the coefficient of the bounded-coefficient encoding comprises finding a feasible solution to a system of inequality constraints.

In another aspect, disclosed herein is a non-transitory computer-readable medium comprising machine-executable code that, upon execution by one or more computer processors, implements a method for setting a system of superconducting qubits having a Hamiltonian representative of a polynomial on a bounded integer domain via bounded-coefficient encoding, the method comprising: using one or more computer processors to obtain (i) the polynomial on the bounded integer domain and (ii) integer encoding parameters; computing the bounded-coefficient encoding using the integer encoding parameters; recasting each integer variable as a linear function of binary variables using the bounded-coefficient encoding, and providing additional constraints on the attained binary variables to avoid degeneracy in the encoding, if required by a user; substituting each integer variable with an equivalent binary representation, and computing the coefficients of the equivalent binary representation of the polynomial on the bounded integer domain; performing a degree reduction on the obtained equivalent binary representation of the polynomial on the bounded integer domain to provide an equivalent polynomial of degree at most two in binary variables; and setting local field biases and coupling strengths on the system of superconducting qubits using the coefficients of the derived polynomial of degree at most two in several binary variables.

Disclosed is a method for setting a system of superconducting qubits having a Hamiltonian representative of a polynomial on a bounded integer domain via bounded-coefficient encoding, the method comprising obtaining (i) the polynomial on the bounded integer domain and (ii) integer encoding parameters; computing the bounded-coefficient encoding using the integer encoding parameters; recasting each integer variable as a linear function of binary variables using the bounded-coefficient encoding, and providing additional constraints on the attained binary variables to avoid degeneracy in the encoding, if required by a user; substituting each integer variable with an equivalent binary representation, and computing the coefficients of the equivalent binary representation of the polynomial on the bounded integer domain; performing a degree reduction on the obtained equivalent binary representation of the polynomial on the bounded integer domain to provide an equivalent polynomial of degree at most two in binary variables; and setting local field biases and coupling strengths on the system of superconducting qubits using the coefficients of the derived polynomial of degree at most two in several binary variables.

In some embodiments, the obtaining of a polynomial in n variables on a bounded integer domain comprises of providing the plurality of terms in the polynomial; each term of the polynomial further comprises of the coefficient of the term and a list of size n representative of the power of each variables in the term in the matching index. The obtaining of a polynomial on a bounded integer domain further comprises of obtaining a list of upper bounds on each integer variable.

In a particular case where the provided polynomial is of degree at most two, the obtaining of a polynomial on bounded domain comprises of providing coefficients qᵢ of each linear term xᵢ for i=1, . . . , n, and coefficients Qᵢⱼ+Qⱼᵢ of each quadratic term xᵢyᵢ for all choices of distinct elements {i,j}⊂ {1, . . . , n} and an upper bound on each integer variable.

In some embodiments, the obtaining of integer encoding parameters comprises of either obtaining an upper bound on the value of the coefficients of the encoding directly; or obtaining the error tolerance Σₗ and ∈_{c} of the local field biases and couplings, respectively, and computing the upper bound of the coefficients of the encoding from these error tolerances. This application proposes a technique for computing upper bound of the coefficients of the encoding from ∈ₗ and ∈_{c} for the special case that the provided polynomial is of degree at most two.

In some embodiments, the integer encoding parameters are obtained from at least one of a user, a computer, a software package and an intelligent agent.

In some embodiments, the bounded-coefficient encoding is derived and the integer variables are represented as a linear function of a set of binary variables using the bounded-coefficient encoding, and a system of non-degeneracy constraints is returned.

In another aspect, disclosed is a digital computer comprising: a central processing unit; a display device; a memory unit comprising an application for storing data and computing arithmetic operations; and a data bus for interconnecting the central processing unit, the display device, and the memory unit.

In another aspect, there is disclosed a non-transitory computer-readable storage medium for storing computer-executable instructions which, when executed, cause a digital computer to perform arithmetic and logical operations.

In another aspect, there is disclosed a system of superconducting qubits comprising; a plurality of superconducting qubits; a plurality of couplings between a plurality of pairs of superconducting qubits; a quantum device control system capable of setting local field biases on each of the superconducting qubits and couplings strengths on each of the couplings.

The method disclosed herein makes it possible to represent a polynomial on a bounded integer domain on a system of superconducting qubits. The method comprises of obtaining (i) the polynomial on the bounded integer domain and (ii) integer encoding parameters; computing the bounded-coefficient encoding using the integer encoding parameters; recasting each integer variable as a linear function of binary variables using the bounded-coefficient encoding, and providing additional constraints on the attained binary variables to avoid degeneracy in the encoding, if required by a user; substituting each integer variable with an equivalent binary representation, and computing the coefficients of the equivalent binary representation of the polynomial on the bounded integer domain; performing a degree reduction on the obtained equivalent binary representation of the polynomial on the bounded integer domain to provide an equivalent polynomial of degree at most two in binary variables; and setting local field biases and coupling strengths on the system of superconducting qubits using the coefficients of the derived polynomial of degree at most two in several binary variables.

In some embodiments of this application, the method disclosed herein makes it possible to find the optimal solution of a mixed integer polynomially constrained polynomial programming problem through solving its equivalent binary polynomially constrained polynomial programming problem. In one embodiment, solving a mixed integer polynomially constrained polynomial programming problem comprises finding a binary representation of all polynomials appearing the objective function and the constraints of the problem using the bounded-coefficient encoding and applying the method proposed in U.S. Ser. No. 15/051,271, U.S. Ser. No. 15/014,576, CA2921711 and CA2881033 to the obtained equivalent binary polynomially constrained polynomial programming problem.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a non-limiting example of a method for setting a system of superconducting qubits having a Hamiltonian representative of a polynomial on a bounded integer domain; in this case, a flowchart of all steps used for setting a system of superconducting qubits in such a way.

FIG. 2 shows a non-limiting example of a method for setting a system of superconducting qubits having a Hamiltonian representative of a polynomial on a bounded integer domain; in this case, a diagram of a system comprising of a digital computer interacting with a system of superconducting qubits.

FIG. 3 shows a non-limiting example of a method for setting a system of superconducting qubits having a Hamiltonian representative of a polynomial on a bounded integer domain; in this case, a detailed diagram of a system comprising of a digital computer interacting with a system of superconducting qubits used for computing the local fields and couplers.

FIG. 4 shows a non-limiting example of a method for setting a system of superconducting qubits having a Hamiltonian representative of a polynomial on a bounded integer domain; in this case, a flowchart of a step for providing a polynomial on a bounded integer domain.

FIG. 5 shows a non-limiting example of a method for setting a system of superconducting qubits having a Hamiltonian representative of a polynomial on a bounded integer domain; in this case, a flowchart of a step for providing encoding parameters.

FIG. 6 shows a non-limiting example of a method for setting a system of superconducting qubits having a Hamiltonian representative of a polynomial on a bounded integer domain; in this case, a flowchart of a step for computing the bounded-coefficient encoding.

FIG. 7 shows a non-limiting example of a method for setting a system of superconducting qubits having a Hamiltonian representative of a polynomial on a bounded integer domain; in this case, a flowchart of a step for converting a polynomial on a bounded integer domain to an equivalent polynomial in several binary variables.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The method disclosed herein can be applied to any quantum system of superconducting qubits, comprising local field biases on the qubits, and a plurality of couplings of the qubits, and control systems for applying and tuning local field biases and coupling strengths. Systems of quantum devices as such are disclosed for instance in US20120326720 and US20060225165.

Disclosed invention comprises a method for finding an integer encoding that uses the minimum number of binary variables in representation of an integer variable, while respecting an upper bound on the values of coefficients appearing in the encoding. Such an encoding is referred to as a “bounded-coefficient encoding”. It also comprises a method for providing a system of constraints on the binary variables to prevent degeneracy of the bounded-coefficient encoding. Such a system of constraints involving the binary variables is referred to as “a system of non-degeneracy constraints”.

Disclosed invention further comprises of employing bounded-coefficient encoding to represent a polynomial on a bounded integer domain as the Hamiltonian of a system of superconducting qubits.

An advantage of the method disclosed herein is that it enables an efficient method for finding the solution of a mixed integer polynomially constrained polynomial programming problem by finding the solution of an equivalent binary polynomially constrained polynomial programming. In one embodiment, the equivalent binary polynomially constrained polynomial programming problem might be solved by a system of superconducting qubits as disclosed in U.S. Ser. No. 15/051,271, U.S. Ser. No. 15/014,576, CA2921711 and CA2881033.

Described herein is a method for setting a system of superconducting qubits having a Hamiltonian representative of a polynomial on a bounded integer domain via bounded-coefficient encoding, the method comprising: using one or more computer processors to obtaining (i) the polynomial on the bounded integer domain and (ii) integer encoding parameters; computing the bounded-coefficient encoding using the integer encoding parameters; recasting each integer variable as a linear function of binary variables using the bounded-coefficient encoding, and providing additional constraints on the attained binary variables to avoid degeneracy in the encoding, if required by a user; substituting each integer variable with an equivalent binary representation, and computing the coefficients of the equivalent binary representation of the polynomial on the bounded integer domain; performing a degree reduction on the obtained equivalent binary representation of the polynomial on the bounded integer domain to provide an equivalent polynomial of degree at most two in binary variables; and setting local field biases and coupling strengths on the system of superconducting qubits using the coefficients of the derived polynomial of degree at most two in several binary variables.

Also described herein, in certain embodiments, is a system comprising: a sub-system of superconducting qubits; a computer operatively coupled to the sub-system of superconducting qubits, wherein the computer comprises at least one computer processor, an operating system configured to perform executable instructions, and a memory; and a computer program including instructions executable by the at least one computer processor to generate an application for setting the sub-system of superconducting qubits having a Hamiltonian representative of a polynomial on a bounded integer domain via bounded-coefficient encoding, the application comprising: a first module programmed or otherwise configured to obtain the polynomial on the bounded integer domain; a second module programmed or otherwise configured to obtain integer encoding parameters; a third module programmed or otherwise configured to compute a bounded-coefficient encoding using the integer encoding parameters; a fourth module programmed or otherwise configured to recast each integer variable as a linear function of binary variables using the bounded-coefficient encoding and provide additional constraints on the attained binary variables to avoid degeneracy in the encoding, if required by a user; a fifth module programmed or otherwise configured to substitute each integer variable with an equivalent binary representation, and compute the coefficients of the equivalent binary representation of the polynomial on the bounded integer domain; a software module programmed or otherwise configured to reduce a polynomial in several binary variables to a polynomial of degree at most two in several binary variables; a software module programmed or otherwise configured to provide an assignment of binary variables of the obtained equivalent binary polynomial of degree at most two to qubits; and a software module programmed or otherwise configured to set local field biases and coupling strengths on the system of superconducting qubits using the coefficients of the derived polynomial of degree at most two in several binary variables.

Also described herein, in certain embodiments, is a non-transitory computer-readable medium comprising machine-executable code that, upon execution by one or more computer processors, implements a method for setting a system of superconducting qubits having a Hamiltonian representative of a polynomial on a bounded integer domain via bounded-coefficient encoding, the method comprising: using one or more computer processors to obtain (i) the polynomial on the bounded integer domain and (ii) integer encoding parameters; computing the bounded-coefficient encoding using the integer encoding parameters; recasting each integer variable as a linear function of binary variables using the bounded-coefficient encoding, and providing additional constraints on the attained binary variables to avoid degeneracy in the encoding, if required by a user; substituting each integer variable with an equivalent binary representation, and computing the coefficients of the equivalent binary representation of the polynomial on the bounded integer domain; performing a degree reduction on the obtained equivalent binary representation of the polynomial on the bounded integer domain to provide an equivalent polynomial of degree at most two in binary variables; and setting local field biases and coupling strengths on the system of superconducting qubits using the coefficients of the derived polynomial of degree at most two in several binary variables.

### Various Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

The term “integer variable” and like terms refer to a data structure for storing integers in a digital system, between two integers l and u where l≦u. The integer l is called the “lower bound” and the integer u is called the “upper bound” of the integer variable x.

It is appreciated by the skilled addressee that every integer variable x̅ with lower and upper bounds l and u respectively, can be transformed to a bounded integer variable x with lower and upper bounds 0 and u−l respectively.

Accordingly, herein the term “bounded integer variable” refers to an integer variable which may represent integer values with lower bound equal to 0. One may denote a bounded integer variable x with upper bound u by x∈{0, 1, . . . , u}.

The term “binary variable” and like terms refer to a data structure for storing integers 0 and 1 in a digital system. It is appreciated that in some embodiments computer bits are used to store such binary variables.

The term “integer encoding” of a bounded integer variable a refers to a tuple c₁, . . . , c_{d}) of integers such that the identity x̅=Σᵢ₌₁^{d}cᵢy̅ᵢ is satisfied for every possible value of x using a choice of binary numbers y̅₁, . . . , ŷ_{d} for binary variables y₁, . . . , y_{d}.

The term “bounded-coefficient encoding” with bound M, refers to an integer encoding (c₁, . . . , c_{d}) of a bounded integer variable x such that

cᵢ≦M for all i=1, . . . ,d

and uses the least number of binary variables y₁, . . . , y_{d} amongst all encodings of x satisfying these inequalities.

The term “a system of non-degeneracy constraints” refers to a system of constraints that makes the equation x̅=Σᵢ₌₁^{d}cᵢy̅ᵢ have a unique binary solution (y̅₁, . . . , y̅_{d}) for every choice of value x̅ for variable x.

The term “polynomial on a bounded integer domain” and like terms mean a function of the form

$$f ( x ) = {\sum }_{t = 1}^{T} {Q}_{t} {\prod }_{i = 1}^{n} {x}_{i}^{{p}_{i}^{t}} .$$

in several integer variables xᵢ∈{0, 1, 2, . . . , κᵢ} for i=1, . . . , n, where pᵢ^{t}≧0 is an integer denoting the power of variable xᵢ in t-th term and κᵢ is the upper bound of xᵢ.

The term “polynomial of degree at most two on bounded integer domain” and like terms mean a function of the form

$$f ( x ) = {\sum }_{i , j = 1}^{n} {Q}_{ij} {x}_{i} {x}_{j} + {\sum }_{i = 1}^{n} {q}_{i} {x}_{i}$$

in several integer variables xᵢ∈{0, 1, 2, . . . , κᵢ} for i=1, . . . , n, where κᵢ is the upper bound of xᵢ.

It is appreciated that a polynomial of degree at most two on binary domain, can be represented by a vector of linear coefficients (q₁, . . . , qₙ) and an n×n symmetric matrix Q=(Qᵢⱼ) with zero diagonal.

The term “mixed-integer polynomially constrained polynomial programming” problem and like terms mean finding the minimum of a polynomial y=ƒ(x) in several variables x=(x₁, . . . , xₙ), that a nonempty subset of them indexed by S⊂ {1, . . . , n} are bounded integer variables and the rest are binary variables, subject to a (possibly empty) family of equality constraints determined by a (possibly empty) family of e equations gⱼ(x)=0 for j=1, . . . , e and a (possibly empty) family of inequality constraints determined by a (possibly empty) family of l inequalities hⱼ(x)≦0 for j=1, . . . , l. Here, all functions ƒ(x), gᵢ(x) for i=1, . . . , e and hⱼ(x) for j=1, . . . , l are polynomials. It is appreciated that a mixed integer polynomially constrained polynomial programming problem can be represented as:

min ƒ(x)

subject to gᵢ(x)=0 ∀i∈{1, . . . ,e},

hⱼ(x)≦0 ∀j∈{1, . . . ,l},

xₛ∈{0, . . . ,κₛ} ∀s∈S⊂{1, . . . ,n},

xₛ∈{0,1} ∀s∉S.

The above mixed integer polynomially constrained polynomial programming problem will be denoted by (P_{I}) and the optimal value of it will be denoted by v(P_{I}). An optimal solution, denoted by x*, is a vector at which the objective function attains the value v(P_{I}) and all constraints are satisfied.

The term “polynomial of degree at most two on binary domain” and like terms mean a function of form ƒ(x)=Σ_{i,j=1}ⁿQᵢⱼxᵢxⱼ+Σᵢ₌₁ⁿqᵢxᵢ defined on several binary variables xᵢ∈{0,1} for i=1, . . . , n.

It is appreciated that a polynomial of degree at most two on binary domain, can be represented by a vector of linear coefficients (q₁, . . . , qₙ) and a n×n symmetric matrix Q=(Qᵢⱼ) with zero diagonal.

The term “binary polynomially constrained polynomial programming” problem and like terms mean a mixed-integer polynomially constrained polynomial programming P_{I} such that S=Ø:

min ƒ(x)

subject to gᵢ(x)=0 ∀i∈{1, . . . ,e}

hⱼ(x)≦0 ∀j∈{1, . . . ,l}

xₖ∈{0,1} ∀k∈S{1, . . . ,n}.

The above binary polynomially constrained polynomial programming problem is denoted by P_{B} and its optimal value is denoted by v(P_{B}).

Two mathematical programming problems are called “equivalent” if having the optimal solution of each one of them, the optimal solution of the other one can be computed in polynomial time of the size of former optimal solution.

The term “qubit” and like terms generally refer to any physical implementation of a quantum mechanical system represented on a Hilbert space and realizing at least two distinct and distinguishable eigenstates representative of the two states of a quantum bit. A quantum bit is the analogue of the digital bits, where the ambient storing device may store two states |0) and |1) of a two-state quantum information, but also in superpositions

α|0)+β|1)

of the two states. In various embodiments, such systems may have more than two eigenstates in which case the additional eigenstates are used to represent the two logical states by degenerate measurements. Various embodiments of implementations of qubits have been proposed; e.g. solid state nuclear spins, measured and controlled electronically or with nuclear magnetic resonance, trapped ions, atoms in optical cavities (cavity quantum-electrodynamics), liquid state nuclear spins, electronic charge or spin degrees of freedom in quantum dots, superconducting quantum circuits based on Josephson junctions [Barone and Paternò, 1982, Physics and Applications of the Josephson Effect, John Wiley and Sons, New York; Martinis et al., 2002, Physical Review Letters 89, 117901] and electrons on Helium.

The term “local field”, refers to a source of bias inductively coupled to a qubit. In one embodiment a bias source is an electromagnetic device used to thread a magnetic flux through the qubit to provide control of the state of the qubit [US20060225165].

The term “local field bias” and like terms refer to a linear bias on the energies of the two states |0) and |1) of the qubit. In one embodiment the local field bias is enforced by changing the strength of a local field in proximity of the qubit [US20060225165].

The term “coupling” of two qubits H₁ and H₂ is a device in proximity of both qubits threading a magnetic flux to both qubits. In one embodiment, a coupling may consist of a superconducting circuit interrupted by a compound Josephson junction. A magnetic flux may thread the compound Josephson junction and consequently thread a magnetic flux on both qubits [US20060225165].

The term “coupling strength” between qubits H₁ and H₂ refer to a quadratic bias on the energies of the quantum system comprising both qubits. In one embodiment the coupling strength is enforced by tuning the coupling device in proximity of both qubits.

The term “quantum device control system”, refers to a system comprising a digital processing unit capable of initiating and tuning the local field biases and couplings strengths of a quantum system.

The term “system of superconducting qubits” and like, refers to a quantum mechanical system comprising a plurality of qubits and plurality of couplings between a plurality of pairs of the plurality of qubits, and further comprising a quantum device control system.

It is appreciated that a system of superconducting qubits may be manufacture in various embodiments. In one embodiment a system of superconducting qubits is a “quantum annealer”.

The term “quantum annealer” and like terms mean a system of superconducting qubits that carries optimization of a configuration of spins in an Ising spin model using quantum annealing as described, for example, in Farhi, E. et al., “Quantum Adiabatic Evolution Algorithms versus Simulated Annealing” arXiv.org: quant ph/0201031 (2002), pp. 1-16. An embodiment of such an analog processor is disclosed by McGeoch, Catherine C. and Cong Wang, (2013), “Experimental Evaluation of an Adiabatic Quantum System for Combinatorial Optimization” Computing Frontiers,” May 14-16, 2013 (http://www.cs.amherst.edu/ccm/cf14-mcgeoch.pdf) and also disclosed in the Patent Application US 2006/0225165.

### Steps and Architecture for Setting a System of Superconducting Qubits

In some embodiments, the methods, systems, and media described herein include a series of steps for setting a system of superconducting qubits having a Hamiltonian representative of a polynomial on a bounded integer domain via bounded-coefficient encoding. In some embodiments, the method disclosed herein can be used in conjunction with any method on any solver for solving a binary polynomially constrained polynomial programming problem to solve a mixed-integer polynomially constrained polynomial programming problem.

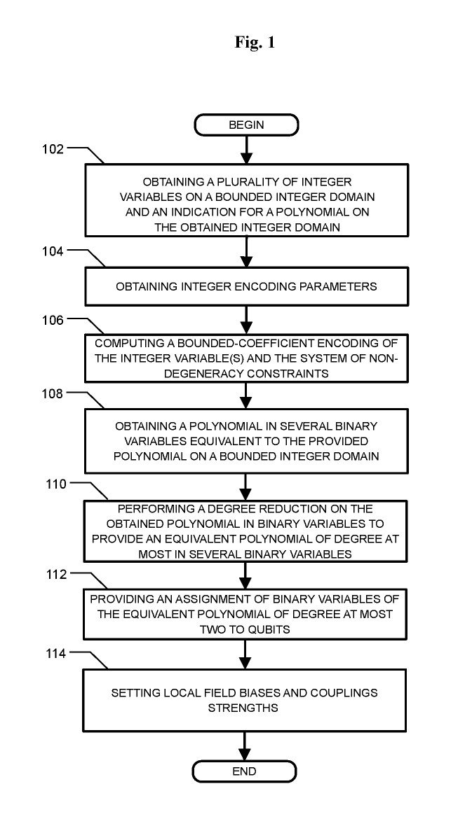

Referring to FIG. 1, in a particular embodiment, a flowchart of all steps is presented as for setting a system of superconducting qubits having a Hamiltonian representative of a polynomial on a bounded integer domain. Specifically, processing step 102 is shown to be obtaining a plurality of integer variables on a bounded integer domain and an indication for a polynomial in those variables. Processing step 104 is disclosed as for obtaining integer encoding parameters. Processing step 106 is used to be computing a bounded-coefficient encoding of the integer variable(s) and the system of non-degeneracy constraints. Processing step 108 is displayed to be obtaining a polynomial in several binary variables equivalent to the provided polynomial on a bounded integer domain. Processing step 110 is shown to be performing a degree reduction on the obtained polynomial in several binary variables to provide a polynomial of degree at most two in several binary variables. Processing step 112 is shown to be providing an assignment of binary variables of the equivalent polynomial of degree at most two to qubits. Processing step 112 is used to be setting local field biases and couplings strengths.

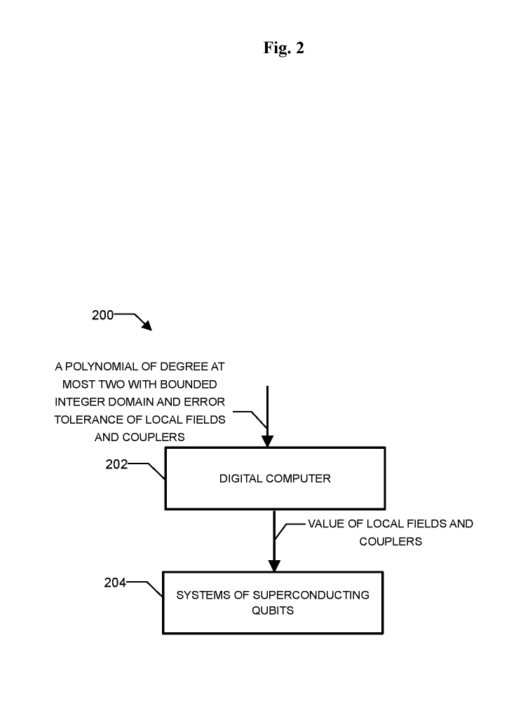

Referring to FIG. 2, in a particular embodiment, a diagram of a system for setting a system of superconducting qubits having a Hamiltonian representative of a polynomial on a bounded integer domain is demonstrated to be comprising of a digital computer interacting with a system of superconducting qubits.

Specially, there is shown an embodiment of a system 200 in which an embodiment of the method for setting a system of superconducting qubits in such a way that its Hamiltonian is representative of a polynomial on a bounded integer domain may be implemented. The system 200 comprises a digital computer 202 and a system 204 of superconducting qubits. The digital computer 202 receives a polynomial on a bounded integer domain and the encoding parameters and provides the bounded-coefficient encoding, a system of non-degeneracy constraints, and the values of local fields and couplers for the system of superconducting qubits.

It will be appreciated that the polynomial on a bounded integer domain may be provided according to various embodiments. In one embodiment, the polynomial on a bounded integer domain is provided by a user interacting with the digital computer 202. Alternatively, the polynomial on a bounded integer domain is provided by another computer, not shown, operatively connected to the digital computer 202. Alternatively, the polynomial on a bounded integer domain is provided by an independent software package. Alternatively, the polynomial on a bounded integer domain is provided by an intelligent agent.

It will be appreciated that the integer encoding parameters may be provided according to various embodiments. In one embodiment, the integer encoding parameters are provided by a user interacting with the digital computer 202. Alternatively, the integer encoding parameters are provided by another computer, not shown, operatively connected to the digital computer 202. Alternatively, the integer encoding parameters are provided by an independent software package. Alternatively, the integer encoding parameters are provided by an intelligent agent.

In some embodiments, the skilled addressee appreciates that the digital computer 202 may be any type. In one embodiment, the digital computer 202 is selected from a group consisting of desktop computers, laptop computers, tablet PCs, servers, smartphones, etc.

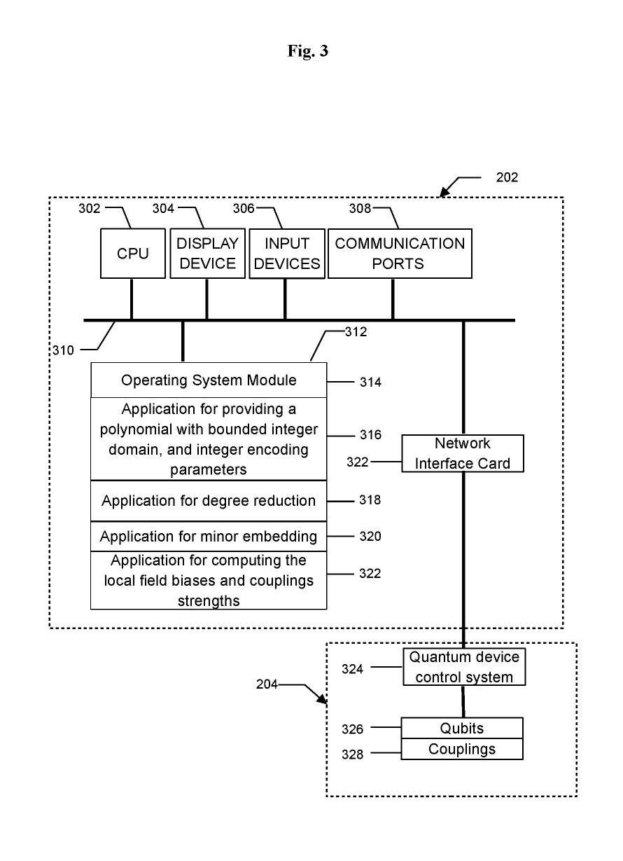

Referring to FIG. 3, in a particular embodiment, a diagram of a system for setting a system of superconducting qubits having a Hamiltonian representative of a polynomial on a bounded integer domain is demonstrated to be comprising of a digital computer used for computing the local fields and couplers.

Further referring to FIG. 3, there is shown an embodiment of a digital computer 202 interacting with a system 204 of superconducting qubits. It will be appreciated that the digital computer 202 may also be broadly referred to as a processor. In this embodiment, the digital computer 202 comprises a central processing unit (CPU) 302, also referred to as a microprocessor, a display device 304, input devices 306, communication ports 308, a data bus 310, a memory unit 312 and a network interface card (NIC) 322.

The CPU 302 is used for processing computer instructions. It's appreciated that various embodiments of the CPU 302 may be provided. In one embodiment, the central processing unit 302 is a CPU Core i7-3820 running at 3.6 GHz and manufactured by Intel™.

The display device 304 is used for displaying data to a user. The skilled addressee will appreciate that various types of display device 304 may be used. In one embodiment, the display device 304 is a standard liquid-crystal display (LCD) monitor.

The communication ports 308 are used for sharing data with the digital computer 202. The communication ports 308 may comprise, for instance, a universal serial bus (USB) port for connecting a keyboard and a mouse to the digital computer 202. The communication ports 308 may further comprise a data network communication port such as an IEEE 802.3 port for enabling a connection of the digital computer 202 with another computer via a data network. The skilled addressee will appreciate that various alternative embodiments of the communication ports 308 may be provided. In one embodiment, the communication ports 308 comprise an Ethernet port and a mouse port (e.g., Logitech™).

The memory unit 312 is used for storing computer-executable instructions. It will be appreciated that the memory unit 312 comprises, in one embodiment, an operating system module 314. It will be appreciated by the skilled addressee that the operating system module 314 may be of various types. In an embodiment, the operating system module 314 is OS X Yosemite manufactured by Apple™.

The memory unit 312 further comprises an application for providing a polynomial on a bounded integer domain, and integer encoding parameters 316. The memory unit 312 further comprises an application for reducing the degree of a polynomial in several binary variables to at most two 318. It is appreciated that the application for reducing the degree of a polynomial in several binary variables can be of various kinds. One embodiment of an application for reducing degree of a polynomial in several binary variables to at most two is disclosed in [H. Ishikawa, “Transformation of General Binary MRF Minimization to the First-Order Case,” in IEEE Transactions on Pattern Analysis and Machine Intelligence, vol. 33, no. 6, pp. 1234-1249, June 2011] and [Martin Anthony, Endre Boros, Yves Crama, and Aritanan Gruber. 2016. Quadratization of symmetric pseudo-Boolean functions. Discrete Appl. Math. 203, C (April 2016), 1-12. DOI=http://dx.doi.org/10.1016/j.dam.2016.01.001]. The memory unit 312 further comprises an application for minor embedding of a source graph to a target graph 320. It is appreciated that the application for minor embedding can be of various kinds. One embodiment of an application for minor embedding of a source graph to a target graph is disclosed in [U.S. Pat. No. 8,244,662]. The memory unit 312 further comprises an application for computing the local field biases and couplings strengths.

Each of the central processing unit 302, the display device 304, the input devices 306, the communication ports 308 and the memory unit 312 is interconnected via the data bus 310.

The system 202 further comprises a network interface card (NIC) 322. The application 320 sends the appropriate signals along the data bus 310 into NIC 322. NIC 322, in turn, sends such information to quantum device control system 324.

The system 204 of superconducting qubits comprises a plurality of superconducting quantum bits and a plurality of coupling devices. Further description of such a system is disclosed in [US20060225165].

The system 204 of superconducting qubits, further comprises a quantum device control system 324. The control system 324 itself comprises coupling controller for each coupling in the plurality 328 of couplings of the device 204 capable of tuning the coupling strengths of a corresponding coupling, and local field bias controller for each qubit in the plurality 326 of qubits of the device 204 capable of setting a local field bias on each qubit.

### Obtaining a Plurality of Integer Variables on a Bounded Integer Domain

In some embodiments, the methods, systems, and media described herein include a series of steps for setting a system of superconducting qubits having a Hamiltonian representative of a polynomial on a bounded integer domain via bounded-coefficient encoding. In some embodiments, a processing step is shown to be obtaining a plurality of integer variables on a bounded integer domain and an indication for a polynomial in those variables.

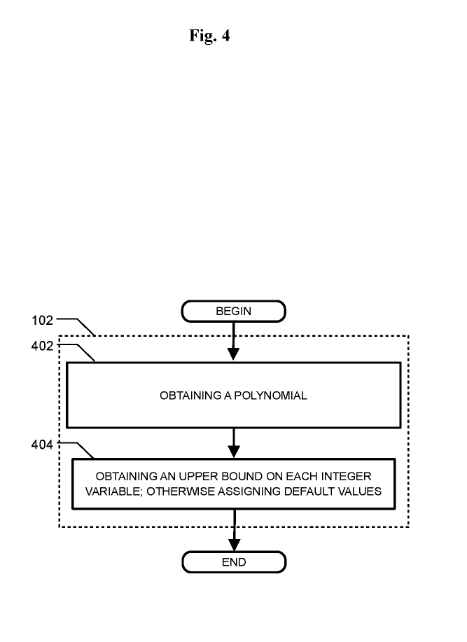

Referring to FIG. 1 and according to processing step 102, a polynomial on a bounded integer domain is obtained. Referring to FIG. 4, in a particular embodiment, there is shown of a detailed processing step for providing a polynomial on a bounded integer domain.

According to processing step 402, the coefficient of each term of a polynomial and the degree of each variable in the corresponding term are provided. It is appreciated that providing the coefficient and degree of each variable in each term can be performed in various embodiments. In one embodiments a list of form [Qₜ, p₁^{t}, p₂^{t}, . . . , pₙ^{t}] is provided for each term of the polynomial in which Qₜ is the coefficient of the t-th term and pᵤ^{t} is the power of i-th variable in the t-th term.

In another embodiment, and in the particular case that the provided polynomial is of degree at most two a list (q₁, . . . , qₙ) and a n×n symmetric matrix Q=(Qᵢⱼ) is provided. It is appreciated that a single bounded integer variable is an embodiment of a polynomial of degree at most two in which n=1, q₁=1 and Q=(Q₁₁)=(0).

It the same embodiment, it is also appreciated that if Qᵢⱼ=0 for all i,j=1, . . . , n, the provided polynomial is a linear function.

It will be appreciated that the providing of a polynomial may be performed according to various embodiments.

As mentioned above and in one embodiment, the coefficients of a polynomial are provided by a user interacting with the digital computer 202. Alternatively, the coefficients of a polynomial are provided by another computer operatively connected to the digital computer 202. Alternatively, the coefficients of a polynomial are provided by an independent software package. Alternatively, an intelligent agent provides the coefficients of a polynomial.

According to processing step 404, an upper bound on each bounded integer variable is provided. It will be appreciated that the providing of upper bounds on the bounded integer variables may be performed according to various embodiments.

As mentioned above and in one embodiment, the upper bounds on the integer variables are provided by a user interacting with the digital computer 202. Alternatively, the upper bounds on the integer variables are provided by another computer operatively connected to the digital computer 202. Alternatively, the upper bounds on the integer variables are provided by an independent software package or a computer readable and executable subroutine. Alternatively, an intelligent agent provides the upper bounds on the integer variables.

### Obtaining Integer Encoding Parameters

In some embodiments, the methods, systems, and media described herein include a series of steps for setting a system of superconducting qubits having a Hamiltonian representative of a polynomial on a bounded integer domain via bounded-coefficient encoding. In some embodiments, a processing step is shown to be obtaining integer encoding parameters. Referring to FIG. 1 and processing step 104, the integer encoding parameters are obtained.

It is appreciated that the integer encoding parameters comprises of either obtaining an upper bound on the coefficients cᵢ's of the bounded-coefficient encoding directly; or obtaining the error tolerances ∈ₗ and ∈_{c} of the local field biases and couplings strengths, respectively. If the upper bound on the coefficients cᵢ's is not provided directly, it is computed by the digital computer 202 as described in the processing step 504.

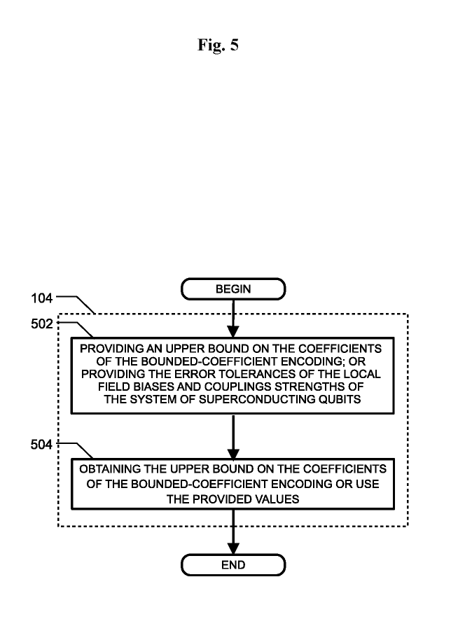

Referring to FIG. 5 and according to processing step 502, an upper bound on the coefficients of the bounded-coefficient encoding may be provided. It will be appreciated that the providing of the upper bound on the coefficients of the bounded-coefficient encoding may be performed according to various embodiments. In one embodiment, the upper bound on the coefficients of the bounded-coefficient encoding is provided directly by a user, a computer, a software package or an intelligent agent.

Still referring to processing step 502, if the upper bound on the coefficients of the bounded-coefficient encoding is not directly provided, the error tolerances of the local field biases and the couplings strengths of the system of superconducting qubits are provided. It will be appreciated that the providing of the error tolerances of the local field biases and the couplings strengths of the system of superconducting qubits may be performed according to various embodiments. In one embodiment, the error tolerances of the local field biases and the couplings strengths of the system of superconducting qubits are provided directly by user, a computer, a software package or an intelligent agent.

According to processing steps 504, the upper bound on the coefficients of the bounded-coefficient encoding is obtained based on the error tolerances ∈ₗ and ∈_{c} respectively of the local field biases and couplings strengths of the system of superconducting qubits.

Still referring to processing step 504 the upper bound of the values of the coefficients of the integer encoding is obtained. The description of the system used for computing the upper bound of the coefficients of the bounded-coefficient encoding when ∈ₗ and ∈_{c} are provided, is now presented in details.

If the provided polynomial is only a single bounded integer variable x, then the upper bound on the coefficients of the bounded-coefficient encoding of x denoted by μ^{x} is computed and stored as

$${μ}^{x} = ⌊ \frac{1}{{ε}_{l}} ⌋ .$$

If the provided polynomial is of degree one, i.e. ƒ(x)=Σᵢ₌₁ⁿqᵢxᵢ, then the upper bound of the coefficients of the bounded-coefficient encoding for variable xᵢ is computed and stored as

$${μ}^{{x}_{i}} = ⌊ \frac{{min}_{j} \{ \vert {q}_{j} \vert \}}{\vert {q}_{i} \vert {ε}_{l}} ⌋ .$$

It is appreciated that if μ^{x}^{ᵢ} for i=1, . . . , n are required to be of equal value, the upper bound of the coefficients of the bounded-coefficient encoding is stored as

$$μ = ⌊ \frac{{min}_{j} \{ \vert {q}_{j} \vert \}}{{max}_{j} \{ \vert {q}_{j} \vert \} {ε}_{l}} ⌋ .$$

It is appreciated that this value of μ coincides with minⱼ{μ^{x}^{ⱼ}}.

If the provided polynomial is of degree at least two, i.e.,

$$f ( x ) = {\sum }_{t = 1}^{T} {Q}_{t} {\prod }_{i = 1}^{n} {x}_{i}^{{p}_{i}^{t}} ,$$

and there exists a t such that Σᵢ₌₁ⁿpᵢ^{t}≧2, the upper bounds on the coefficients of the bounded-coefficient encodings for variables xᵢ for i=1, . . . , n must be such that the coefficient of the equivalent polynomial of degree at most two in several variables derived after the substitution of binary representation of Xᵢ's and performing the degree reduction, i.e.,

$$f ( x ) = {\sum }_{i = 1}^{\overline{n}} {q}_{i}^{B} {y}_{i} + {\sum }_{i , {j = 1}_{i \neq j}}^{\overline{n}} {Q}_{ij}^{B} {y}_{i} {y}_{j}$$

satisfy the following inequalities:

$$\frac{{min}_{i} \vert {q}_{i}^{B} \vert}{{max}_{i} \vert {q}_{i}^{B} \vert} \geq ∈ {ε}_{l} , and \frac{{min}_{i} \vert {q}_{ij}^{E} \vert}{{max}_{i} \vert {q}_{ij}^{B} \vert} \geq {ε}_{c} .$$

It is appreciated that finding the upper bounds on the coefficients of the bounded-coefficient encoding such that the above inequalities are satisfied can be done in various embodiments. In one embodiment, a variant of a bisection search may be employed to find the upper bounds on the coefficients of the bounded-coefficient encoding such that the above inequalities are satisfied. In another embodiment a suitable heuristic search utilizing the coefficients and degree of the polynomial may be employed to find the upper bounds on the coefficients of the bounded-coefficient encoding such that the above inequalities are satisfied.

In a particular case that ƒ(x)=Σᵢ₌₁ⁿqᵢxᵢ+Σ_{i,j=1}ⁿQᵢⱼxᵢxⱼ, and Qᵢᵢ and qᵢ are of the same sign, the above set of inequalities are reduced to

$$\vert {Q}_{ii} \vert {( {μ}^{{x}_{i}} )}^{2} + \vert {q}_{i} \vert {μ}^{{x}_{i}} \leq \frac{{m}_{l}}{{ε}_{l}} for i = 1 , … , n , \\ {μ}^{{x}_{i}} \leq \sqrt{\frac{{m}_{c}}{\vert {Q}_{ii} \vert {ε}_{c}}} for i = 1 , … , n \text{:} {Q}_{ii} \neq 0$$

$${μ}^{{x}_{i}} {μ}^{{x}_{j}} \leq \frac{{m}_{c}}{\vert {Q}_{ii} \vert {ε}_{c}} for i , j = 1 , … , n \text{:} {Q}_{ij} \neq 0$$

for mₗ=minᵢ{|Qᵢᵢ+qᵢ|} and m_{c}=min_{i,j}{|Qᵢᵢ|,|Qᵢⱼ|}. Various methods may be employed to find μ^{x}^{ᵢ} for i=1, . . . , n that satisfy the above set of inequalities. In one embodiment the following mathematical programming model may be solved with appropriate solver on the digital computer 202 to find μ^{x}^{ᵢ} for i=1, . . . , n.

$$min {\sum }_{i = 1}^{n} \frac{{κ}^{{x}_{i}}}{{μ}^{{x}_{i}}} , \\ subject to {{Q}_{ii} ( {μ}^{{x}_{i}} )}^{2} + {q}_{i} {μ}^{{x}_{i}} \leq \frac{{m}_{l}}{{ε}_{l}} for i = 1 , … , n , \\ {μ}^{{x}_{i}} \leq \sqrt{\frac{{m}_{c}}{{Q}_{ii} {ε}_{c}}} for i = 1 , … , n \text{:} {Q}_{ii} \neq 0$$

$${μ}^{{x}_{i}} {μ}^{{x}_{j}} \leq \frac{{m}_{c}}{{Q}_{ii} {ε}_{c}} for i , j = 1 , … , n \text{:} {Q}_{ij} \neq 0$$

In another embodiment a heuristic search algorithm may be employed for finding μ^{x}^{ᵢ} for =1, 2, . . . , n that satisfy the above inequalities.

### Computing a Bounded-Coefficient Encoding of the Integer Variable(s) and the System of Non-Degeneracy Constraints

In some embodiments, the methods, systems, and media described herein include a series of steps for setting a system of superconducting qubits having a Hamiltonian representative of a polynomial on a bounded integer domain via bounded-coefficient encoding. In some embodiments, a processing step is shown to be computing a bounded-coefficient encoding of the integer variable(s) and the system of non-degeneracy constraints. Referring to FIG. 1 and processing step 106, the bounded-coefficient encoding and the system of non-degeneracy constraints are obtained.

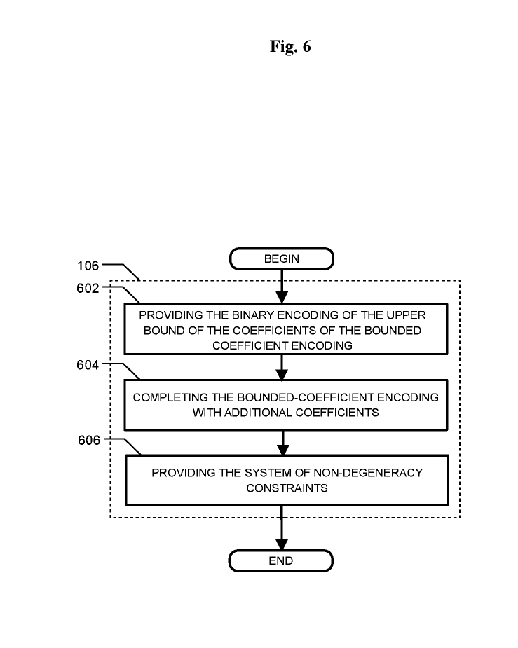

Referring to FIG. 6, in a particular embodiment, it explains how the bounded-coefficient encoding is derived. Herein, it denotes the upper bound on the integer variable x with κ^{x}, and the upper bound on the coefficients used in the integer encoding with μ^{x}. According to processing step 602, it derives the binary encoding of μ^{x}. It sets l_{μ}_{^{x}}=└ log₂ μ^{x}+1┘. Then the binary encoding of μ is set to be

S_{μ}_{^{x}}t=(2ⁱ⁻¹:for i=1, . . . m l_{μ}_{^{x}}).

It is appreciated that if κ^{x}<2^{l}^{_{μ}}^{x} then the binary encoding of κ^{x} does not have any coefficients larger than μ^{x} and the processing step 602 derives

$${c}_{i}^{x} = \{ \begin{matrix}{2}^{i - 1} & for i = 1 , … , ⌊ {log}_{2} {κ}^{x} ⌋ \\ {κ}^{x} - {\sum }_{i = 1}^{⌊ {log}_{2} {κ}^{x} ⌋} {2}^{i - 1} & for i = 1 , … , ⌊ {log}_{2} {κ}^{x} ⌋ + 1\end{matrix}$$

and processing step 604 is skipped.

Still referring to FIG. 6 and according to processing step 604, it completes the bounded-coefficient encoding if required (i.e., κ^{x}≧2^{μ}^{^{x}}) by adding

$${η}_{{μ}^{x}} = ⌊ ( {κ}^{x} - {\sum }_{i = 0}^{{l}_{μ} x} {2}^{i - 1} ) / {μ}^{x} ⌋$$

coefficients of value μ, and one coefficient of value τ^{x}=κ^{x}−Σᵢ₌₀^{l}^{_{μ}}^{x}2ⁱ⁻¹−η_{μ}_{^{x}}μ^{x} if τ is nonzero. Using the derived coefficients, the bounded-coefficient encoding is the integer encoding in which the coefficients are as follows:

$${c}_{i}^{x} = \{ \begin{matrix}{2}^{i - 1} , & for i = 1 , … , {l}_{{μ}^{x}} , \\ {μ}^{x} , & for i = {l}_{{μ}^{x}} + 1 , … , {l}_{{μ}^{x}} + {η}_{{μ}^{x}} , \\ {τ}^{x} , & for i = {l}_{{μ}^{x}} + {η}_{{μ}^{x}} + 1 if {τ}^{x} \neq 0\end{matrix}$$

It is appreciated that the degree of the bounded-coefficient encoding is

$${d}^{x} = \{ \begin{matrix}{l}_{{μ}^{x}} + {η}_{{μ}^{x}} & if {τ}^{x} \neq 0 , \\ {l}_{{μ}^{x}} + {η}_{{μ}^{x}} + 1 & otherwise\end{matrix} .$$

It is also appreciated that in the bounded-coefficient encoding the following identity is satisfied

$${\sum }_{i = 1}^{{d}^{x}} {c}_{i}^{x} = {κ}^{x}$$

For example, if one needs to encode an integer variable that takes maximum value of 24 with integer encoding that has maximum coefficient of 6, the bounded-coefficient encoding would be

c₁=1,c₂=2,c₃=4,c₄=6,c₅=6,c₅=5.

It is appreciated that bounded-coefficient encoding may be derived according to various embodiment. In one embodiment, it is the output of a digital computer readable and executable subroutine.

Still referring to FIG. 6 and according to processing step 606, a system of non-degeneracy constraints is provided. It is appreciated that the system of non-degeneracy constraints may be represented in various embodiments.

In one embodiment the system of non-degeneracy constraints is the following system of linear inequalities:

$${\sum }_{i = 1}^{{l}_{{μ}^{x}}} {y}_{i}^{x} \geq {y}_{{l}_{μ + 1}}^{x} , {y}_{i}^{x} \geq {y}_{i + 1}^{x} , for i = {l}_{{μ}^{x}} + 1 , … , {d}^{x}$$

It is appreciated that the providing of the system of non-degeneracy constraints above may be carried by providing a matrix A of size (d^{x}−l_{μ}_{^{x}}+1)×d^{x} with entries −1,0,1. In this embodiment the system of non-degeneracy constraints is represented by the following system

$$A ( \begin{matrix}{y}_{1}^{x} \\ ⋮ \\ {y}_{{d}^{x}}^{x}\end{matrix} ) \leq ( \begin{matrix}0 \\ ⋮ \\ 0\end{matrix} )$$

Converting from Integer Domain to Binary Variables

In some embodiments, the methods, systems, and media described herein include a series of steps for setting a system of superconducting qubits having a Hamiltonian representative of a polynomial on a bounded integer domain via bounded-coefficient encoding. In some embodiments, a processing step is shown to be providing a polynomial in several binary variables equivalent to the provide polynomial on a bounded integer domain. Referring back to FIG. 1 and according to processing step 108, the provided polynomial on a bounded integer domain is converted to an equivalent polynomial in several binary variables.

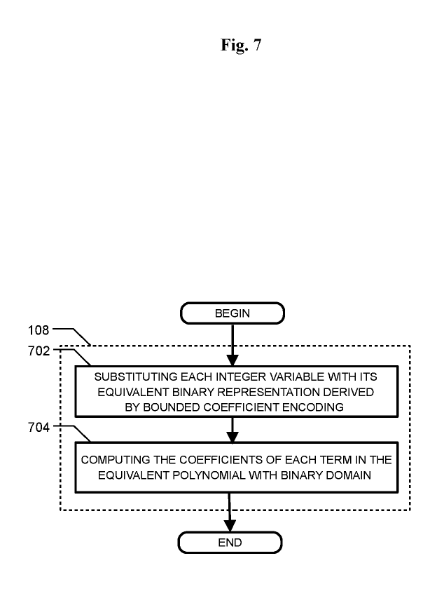

Referring to FIG. 7 and processing step 702, each integer variable xᵢ is represented with the following linear function

$${x}_{i} = {\sum }_{k = 1}^{{d}^{{x}_{i}}} {c}_{k}^{{x}_{i}} {y}_{k}^{{x}_{i}}$$

of binary variables yₖ^{x}^{ᵢ} for k=1, . . . , d^{x}^{ᵢ}.

Still referring to FIG. 7 and according to processing step 704, the coefficients of the polynomial on binary variables equivalent to the obtained polynomial on bounded integer domain are computed.

For each variable xᵢ in the obtained polynomial on a bounded integer domain, herein it introduces d^{x}^{ᵢ} binary variables y₁^{x}^{ᵢ}, y₂^{x}^{ᵢ}, . . . , y_{d}_{^{x}}ᵢ^{x}^{ᵢ}.

It is appreciated that the coefficients of the polynomial in several binary variables can be computed in various embodiments.

In one embodiment the computation of the coefficient of the polynomial in several binary variables may be performed according to the method disclosed in the documentation of the SymPy Python library for symbolic mathematics available online at [http://docs.sympy.org/latest/modules/polys/internals.html] in conjunction to the relations of type y^{m}=y for all binary variables.

In a particular case that the obtained polynomial on a bounded integer domain is linear, the resulting polynomial in binary variables is also linear and the coefficient of each variable yₖ^{x}^{ᵢ} is qᵢcₖ^{x}^{ᵢ} for i=1, . . . , n and k=1, . . . , d^{x}^{ᵢ}.

In a particular case that the obtained polynomial on a bounded integer domain is of degree two, then the equivalent polynomial in binary variables is of degree two as well; the coefficients of variable yₖ^{x}^{ᵢ} is qᵢcₖ^{x}^{ᵢ}+Qᵢᵢ(cₖ^{x}^{ᵢ})² for i=1, . . . , n, and k=1, . . . , d^{x}^{ᵢ}; the coefficients corresponding to is yₖ^{x}^{ᵢ}yₗ^{x}^{ᵢ} is Qᵢᵢcₖ^{x}^{ᵢ}cₗ^{x}^{ᵢ} for i=1, . . . , n, k, l=1, . . . , d^{x}^{ᵢ}, and k≠l; and the coefficients corresponding to yₖ^{x}^{ᵢ}yₗ^{x}^{ⱼ} is Qᵢⱼcₖ^{x}^{ᵢ}cₗ^{x}^{ⱼ} for i,j=1, . . . , n, i≠j, k=1, . . . d^{x}^{ᵢ}, and l=1, . . . , d^{x}^{ⱼ}.

### Degree Reduction of the Polynomial in Several Binary Variables

In some embodiments, the methods, systems, and media described herein include a series of steps for setting a system of superconducting qubits having a Hamiltonian representative of a polynomial on a bounded integer domain via bounded-coefficient encoding. In some embodiments, a processing step is shown to be providing a degree reduced form of a polynomial in several binary variables. Referring back to FIG. 1 and according to processing step 110, it provides a polynomial of degree at most two in several binary variables equivalent to the provided polynomial in several binary variables.

It is appreciated that the degree reduction of a polynomial in several binary variables can be done in various embodiments. In one embodiment the degree reduction of a polynomial in several binary variables is done by the method described in [H. Ishikawa, “Transformation of General Binary MRF Minimization to the First-Order Case,” in IEEE Transactions on Pattern Analysis and Machine Intelligence, vol. 33, no. 6, pp. 1234-1249, June 2011]. In another embodiment, the degree reduction of a polynomial in several binary variables is done by the method described in [Martin Anthony, Endre Boros, Yves Crama, and Aritanan Gruber. 2016. Quadratization of symmetric pseudo-Boolean functions. Discrete Appl. Math. 203, C (April 2016), 1-12. DOI=http://dx.doi.org/10.1016/j.dam.2016.01.001].

### Assigning Variables to Qubits

In some embodiments, the methods, systems, and media described herein include a series of steps for setting a system of superconducting qubits having a Hamiltonian representative of a polynomial on a bounded integer domain via bounded-coefficient encoding. In some embodiments, a processing step is shown to be providing an assignment of binary variables of the polynomial of degree at most two equivalent to the provided polynomial on bounded integer domain to qubits. Referring back to FIG. 1 and according to processing step 112, it provides an assignment of the binary variables of the polynomial of degree at most two equivalent to the provided polynomial on bounded integer domain to qubits. In one embodiment the assignment of binary variables to qubits is according to a minor embedding algorithm from a source graph obtained from the polynomial of degree at most two in several binary variables equivalent to the provided polynomial on bounded integer domain to a target graph obtained from the qubits and couplings of the pairs of qubits in the system of superconducting qubits.

It is appreciated that a minor embedding from a source graph to a target graph may be performed according to various embodiments. In one embodiment the algorithm disclosed in [A practical heuristic for finding graph minors—Jun Cai, Bill Macready, Aidan Roy] and in U.S. Patent Application [US 2008/0218519] and [U.S. Pat. No. 8,655,828 B2] is used.

### Setting Local Field Biases and Couplers Strengths

In some embodiments, the methods, systems, and media described herein include a series of steps for setting a system of superconducting qubits having a Hamiltonian representative of a polynomial on a bounded integer domain via bounded-coefficient encoding. In some embodiments, a processing step is shown to be setting local field biases and couplings strengths. Referring back to FIG. 1 and according to processing step 114, the local field biases and couplings strengths on the system of superconducting qubits are tuned.

In the particular case that the obtained polynomial is linear, each logical variable is assigned a physical qubit and the local field bias of qᵢcₖ^{x}^{ᵢ} is assigned to the qubit corresponding to logical variable yₖ^{x}^{ᵢ} for i=1, . . . , n and k=1, . . . , d^{x}^{ᵢ}.

In the particular case where the obtained polynomial is of degree two or more, the degree reduced polynomial in several binary variables equivalent to the provided polynomial is quadratic, and the tuning of local field biases and coupling strength may be carried according to various embodiments. In one embodiment wherein the system of superconducting qubits is fully connected, each logical variable is assigned a physical qubit. In this case, the local field of qubit corresponding to variable y is set as the value of the coefficient of y in the polynomial of degree at most two in several binary variables. The coupling strength of the pair of qubits corresponding to variables y and y′ is set as the value of the coefficient of yy′ in the polynomial of degree at most two in several binary variables.

The following example, illustrates how the method disclosed in this application may be used to recast a mixed-integer polynomially constrained polynomial programming problem to a binary polynomially constrained polynomial programming problem. Consider the optimization problem

min(x₁+x₃)²+x₂.

subject to x₁+(x₂)³≦9,

x₁,x₂∈ [symbol] ₊,

x₃∈{0,1}.

The above problem is a mixed-integer polynomially constrained polynomial programming problem in which all the polynomials are of degree at most three. According to the constraint an upper bound for the integer variable x₁ is 9 and an upper bound for the integer variable x₂ is 2.

Suppose one wants to convert this problem to an equivalent binary polynomially constrained polynomial programming with an integer encoding that has coefficient of at most three. The bounded-coefficient encoding for x₁ is c₁^{x}^{₁}=c₂^{x}^{₁}=2, c₃^{x}^{₁}=3, c₄^{x}^{₁}=3 and the bounded-coefficient encoding for x₂ is c₁^{x}^{₂}=1, c₂^{x}^{₂}=1. The formal presentations for x₁ and x₂ are

x₁=y₁^{x}^{₁}+2y₂^{x}^{₁}+3y₃^{x}^{₁}+3y₄^{x}^{₁}.

x₂=y₁^{x}^{₂}+y₂^{x}^{ₙ}.

Substituting the above linear functions for x₁ and x₂ in the mixed integer polynomially constrained polynomial programming problem it will attain the following equivalent binary polynomially constrained polynomial programming problem:

min(y₁^{x}^{₁}+2y₂^{x}^{₁}+3y₃^{x}^{₁}+3y₄^{x}^{₁}+x₃)²+y₁^{x}^{₂}+y₂^{x}^{₂}.

subject to y₁^{x}^{₁}+2y₂^{x}^{₁}+3y₃^{x}^{₁}+3y₄^{x}^{₁}+(y₁^{x}^{₂}+y₂^{x}^{₂})³≦9,

x₃,y₁^{x}^{₁},y₂^{x}^{₁},y₃^{x}^{₁},y₄^{x}^{₁},y₁^{x}^{₂},y₂^{x}^{₂}∈{0,1}.

If required, it can rule out degenerate solutions by adding the system of non-degeneracy constraints provided by the method disclosed in this application, to the derived binary polynomially constrained polynomial programming problem as mentioned above. For the presented example, the final binary polynomially constrained polynomial programming problem is:

min(y₁^{x}^{₁}+2y₂^{x}^{₁}+3y₃^{x}^{₁}+y₄^{x}^{₁}+x₃)²+y₁^{x}^{₂}+y₂^{x}^{₂},

subject to y₁^{x}^{₁}+2y₂^{x}^{₁}+3y₃^{x}^{₁}+3y₄^{x}^{₁}+(y₁^{x}^{₂}+y₂^{x}^{₂})³≦9.

y₁^{x}^{₁}+y₂^{x}^{₁}≧y₃^{x}^{₁},

y₃^{x}^{₂}≧y₄^{x}^{₁},

y₁^{x}^{₂}≧y₂^{x}^{₂},

x₃,y₁^{x}^{₁},y₂^{x}^{₁},y₃^{x}^{₁},y₄^{x}^{₁},y₁^{x}^{₂},y₂^{x}^{₂}∈{0,1}.

In this particular cases the first constraint of the above problem is of degree three and in the form of

y₁^{x}^{₁}+2y₂^{x}^{₁}+3y₃^{x}^{₁}+3y₄^{x}^{₁}+(y₁^{x}^{₂})³+3(y₁^{x}^{₂})²(y₂^{x}^{₂})+3(y₁^{x}^{₂})(y₂^{x}^{₂})²+(y₂^{x}^{₂})³≧9.

which can be equivalently represented as the degree reduced form of

y₁^{x}^{₁}+2y₂^{x}^{₁}+3y₃^{x}^{₁}+3y₄^{x}^{₁}+(y₁^{x}^{₂})+6(y₁^{x}^{₂})(y₂^{x}^{₂})+(y₂^{x}^{₂})≧9.

### Digital Processing Device

In some embodiments, the quantum-ready software development kit (SDK) described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenB SD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the quantum-ready software development kit (SDK) disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the quantum-ready software development kit (SDK) disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony PSP™ browser.

### Software Modules

In some embodiments, the quantum-ready software development kit (SDK) disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the quantum-ready software development kit (SDK) disclosed herein include one or more databases, or use of the same. In view of the disclosure provided herein, those of skill in the art will recognize that many databases are suitable for storage and retrieval of application information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for using one or more computer processors of a digital computer to generate an equivalent of a polynomial programming problem on a bounded integer domain via bounded-coefficient encoding for efficiently solving the polynomial programming problem using a quantum computing system of superconducting qubits, the method comprising:
(a) using the one or more computer processors of the digital computer to obtain (i) a polynomial on the bounded integer domain and (ii) integer encoding parameters;
(b) computing the bounded-coefficient encoding using the integer encoding parameters;
(c) using the one or more computer processors to transform each integer variable of the polynomial to a linear function of binary variables using the bounded-coefficient encoding, and providing additional constraints on the binary variables to avoid degeneracy in the bounded-coefficient encoding, if required by a user;
(d) substituting each integer variable of the polynomial with an equivalent binary representation, and computing coefficients of an equivalent binary representation of the polynomial on the bounded integer domain;
(e) performing a degree reduction on the equivalent binary representation of the polynomial on the bounded integer domain to generate an equivalent polynomial of a degree of at most two in binary variables; and
(f) setting local field biases and coupling strengths on the quantum computing system of superconducting qubits using the coefficients of the equivalent polynomial of the degree of at most two in binary variables to generate a Hamiltonian representative of the polynomial on the bounded integer domain, which Hamiltonian is usable by the quantum computing system of superconducting qubits to solve the polynomial programming problem.

2. The method of claim 1, wherein the polynomial on the bounded integer domain is a single bounded integer variable.

3. The method of claim 2, wherein (f) comprises assigning to a plurality of qubits a plurality of corresponding local field biases; wherein each local field bias corresponding to each of the qubits in the plurality of qubits is provided using the parameters of the integer encoding.

4. The method of claim 1, wherein the polynomial on the bounded integer domain is a linear function of several bounded integer variables.

5. The method of claim 4, wherein (f) comprises assigning to a plurality of qubits a plurality of corresponding local field biases; wherein each local field bias corresponding to each of the qubits in the plurality of qubits is provided using the linear function and the parameters of the integer encoding.

6. The method of claim 1, wherein the polynomial on the bounded integer domain is a quadratic polynomial of several bounded integer variables.

7. The method of claim 6, wherein (f) comprises embedding the equivalent binary representation of the polynomial of the degree of at most two on the bounded integer domain to a layout of the quantum computing system of superconducting qubits comprising local fields on each of the plurality of the superconducting qubits and couplings in a plurality of pairs of the plurality of the superconducting qubits.

8. The method of claim 1, wherein the quantum computing system of superconducting qubits is a quantum annealer.

9. The method of claim 8, further comprising performing an optimization of the polynomial on the bounded integer domain via bounded-coefficient encoding.

10. The method of claim 9, wherein the optimization of the polynomial on the bounded integer domain via bounded-coefficient encoding is performed by quantum adiabatic evolution of an initial transverse field on the superconducting qubits to a final Hamiltonian representative of the polynomial on the bounded integer domain on a measurable axis.

11. The method of claim 9, wherein the optimization of the polynomial on the bounded integer domain via bounded-coefficient encoding comprises:
(a) providing the equivalent polynomial of the degree of at most two in binary variables;
(b) providing a quantum computing system of non-degeneracy constraints; and
(c) solving a problem of optimization of the equivalent polynomial of the degree of at most two in binary variables subject to the quantum computing system of non-degeneracy constraints as a binary polynomially constrained polynomial programming problem.

12. The method of claim 1, further comprising solving a polynomially constrained polynomial programming problem on a bounded integer domain via bounded-coefficient encoding.

13. The method of claim 12, wherein solving the polynomially constrained polynomial programming problem on the bounded integer domain via bounded-coefficient encoding is performed by quantum adiabatic evolution of an initial transverse field on the superconducting qubits to a final Hamiltonian representative of the polynomial on the bounded integer domain on a measurable axis.

14. The method of claim 12, wherein solving the polynomially constrained polynomial programming problem on the bounded integer domain via bounded-coefficient encoding comprises:
(a) computing the bounded-coefficient encoding of an objective function and a set of constraints of the polynomially constrained polynomial programming problem using the integer encoding parameters to obtain an equivalent polynomially constrained polynomial programming problem in binary variables;
(b) providing a quantum computing system of non-degeneracy constraints;
(c) adding the quantum computing system of non-degeneracy constraints to a set of constraints of the equivalent polynomially constrained polynomial programming problem in binary variables; and
(d) solving a problem of optimization of the equivalent polynomially constrained polynomial programming problem in binary variables.

15. The method of claim 1, wherein the obtaining of the integer encoding parameters comprises obtaining an upper bound on coefficients of the bounded-coefficient encoding directly.

16. The method of claim 1, wherein obtaining the integer encoding parameters comprises obtaining an upper bound on coefficients of the bounded-coefficient encoding based on error tolerances ∈ₗ and ∈_{c} of local field biases and coupling strengths, respectively, of the quantum computing system of superconducting qubits.

17. The method of claim 16, wherein obtaining the upper bound on the coefficients of the bounded-coefficient encoding comprises determining a feasible solution to a quantum computing system of inequality constraints.

18. A system for generating an equivalent of a polynomial programming problem on a bounded integer domain via bounded-coefficient encoding for efficiently solving the polynomial programming problem using a quantum computing system of superconducting qubits, the system comprising:
(a) the quantum computing subsystem of superconducting qubits;
(b) a digital computer operatively coupled to the quantum computing subsystem of superconducting qubits, wherein the digital computer comprises at least one computer processor, an operating system configured to perform executable instructions, and a memory; and
(c) a computer program including instructions executable by the at least one computer processor to generate an application for generating the equivalent of the polynomial programming problem to efficiently solve the polynomial programming problem on the bounded integer domain via bounded-coefficient encoding, the application comprising:
i) a software module programmed or otherwise configured to obtain a polynomial on the bounded integer domain;
ii) a software module programmed or otherwise configured to obtain integer encoding parameters;
iii) a software module programmed or otherwise configured to compute the bounded-coefficient encoding using the integer encoding parameters;
iv) a software module programmed or otherwise configured to (i) transform each integer variable of the polynomial to a linear function of binary variables using the bounded-coefficient encoding and (ii) provide additional constraints on the binary variables to avoid degeneracy in the bounded-coefficient encoding, if required by a user;
v) a software module programmed or otherwise configured to (i) substitute each integer variable of the polynomial with an equivalent binary representation and (ii) compute coefficients of an equivalent binary representation of the polynomial on the bounded integer domain;
vi) a software module programmed or otherwise configured to perform a degree reduction on the equivalent binary representation of the polynomial on the bounded integer domain to generate an equivalent polynomial of a degree of at most two in binary variables; and
vii) a software module programmed or otherwise configured to set local field biases and coupling strengths on the quantum computing subsystem of superconducting qubits using the coefficients of the equivalent polynomial of the degree of at most two in binary variables to generate a Hamiltonian representative of the polynomial on the bounded integer domain, which Hamiltonian is usable by the quantum computing subsystem of superconducting qubits to solve the polynomial programming problem.

19.-29. (canceled)

30. A non-transitory computer-readable medium comprising machine-executable code that, upon execution by a digital computer comprising one or more computer processors, implements a method for using the one or more computer processors to generate an equivalent of a polynomial programming problem on a bounded integer domain via bounded-coefficient encoding for efficiently solving the polynomial programming problem using a quantum computing system of superconducting qubits, the method comprising:
a. using the one or more computer processors to obtain (i) a polynomial of degree at most two on the bounded integer domain and (ii) integer encoding parameters;
b. computing the bounded-coefficient encoding using the integer encoding parameters;
c. using the one or more computer processors to transform each integer variable of the polynomial to a linear function of binary variables using the bounded-coefficient encoding, and providing additional constraints on the binary variables to avoid degeneracy in the bounded-coefficient encoding, if required by a user;
d. substituting each integer variable of the polynomial with an equivalent binary representation, and computing coefficients of an equivalent binary representation of the polynomial on the bounded integer domain;
e. performing a degree reduction on the equivalent binary representation of the polynomial on the bounded integer domain to generate an equivalent polynomial of a degree of at most two in binary variables; and
f. setting local field biases and coupling strengths on the quantum computing system of superconducting qubits using the coefficients of the equivalent polynomial of the degree of at most two in binary variables to generate a Hamiltonian representative of the polynomial on the bounded integer domain which Hamiltonian is usable by the quantum computing system of superconducting qubits to solve the polynomial programming problem.

31. The method of claim 1, further comprising executing the quantum computing system of superconducting qubits having the Hamiltonian to solve the polynomial programming problem.
